(19) United States
(12) Patent Application Publication
(10) Pub. No.: US 2018/0009316 A1
(43) Pub. Date: Jan. 11, 2018

(54) VEHICLE-USER HUMAN-MACHINE INTERFACE APPARATUS AND SYSTEMS

(71) Applicant: Green Ride Ltd., Haifa (IL)

(72) Inventors: Ori DADOOSH, Herzliya (IL); Nadav ATTIAS, Haifa (IL); Liran NAKACHE, Haifa (IL); Ori YEMINI, Elyakhin (IL); Raanan Shimon SHABTAI, Kiryat-Ata (IL); Eitan BERKOVITS, Kiryat Bialik (IL); Avishai DOTAN, Haifa (IL)

(73) Assignee: Green Ride Ltd., Haifa (IL)

(21) Appl. No.: 15/541,552

(22) PCT Filed: Jan. 7, 2016
(86) PCT No.: PCT/IL16/50020

§ 371 Date: Jul. 5, 2017

Related U.S. Application Data
(60) Provisional application No. 62/100,848, filed on Jan. 7, 2015.

(51) Int. Cl. B60K 35/00; G06F 3/147; G06F 3/01; G06F 3/02; G06F 3/0481

(52) U.S. Cl. CPC B60K 35/00; H04B 1/3822; G06F 3/017; G06F 3/02; H04B 1/3877; G06F 3/147; B60K 2350/1076; B60K 2350/1052; B60K 2350/35; B60K 2350/928; B60Y 2200/126; B60K 2350/1004; G06F 3/04817; G06F 3/012

(57) ABSTRACT

The disclosure is directed to systems and system for providing human-machine interface (HMI), and more particularly, to system for providing a part of HMI system and system components for controlling a vehicle, controlling a personal communication device and displaying integrated information from both to the user.

### BACKGROUND

The present disclosure relates to systems and system for providing human-machine interface (HMI), and more particularly, to system for providing a part of HMI system and system components for controlling a vehicle and displaying information to the user.

A user of a vehicle may be required to control a variety of different systems within the vehicle as well as maintain communication with the cloud. Exemplary systems requiring input from the driver may include an audio system, a navigation system, and an external communication system. The user interacts with one or more input mechanisms associated with each system to control the operation thereof. To simplify operation, a separate input mechanism is preferably employed for each controllable feature. For instance, the audio system may have different dedicated inputs for selecting an input source, controlling the volume, adjusting other audio characteristics, etc. With an increased complexity of such systems as well as an increase in the number of such systems in the vehicle, a driver may be required to use reduced number of input devices to control a plurality of systems while still maintaining visual representation of the systems used and their status.

Further, in vehicles having handlebars as the main steering mechanism, surface area available for display may be quite limited and exposure to sunlight while driving may present even more challenges, not to mention the need for safety and maintaining constant contact with the handlebar. Moreover, with the desire of users to maintain connectivity with mobile communication device while driving, in a safe and effective manner, control over the same mobile communication device may be desirable.

Therefore, it is desirable to provide an integrated multifunctional human-machine control interface for the driver of a vehicle, enabling the driver to maintain control over the environment in which they operate.

### SUMMARY

Disclosed, in various embodiments, are human-machine interface system and systems.

In an embodiment, provided herein is a system for providing a display panel as part of a human-machine interface (HMI), comprising: potentially a front transparent panel coupled to a vehicle's steering means; at least two control levers disposed on and/or under a surfaces of the steering means for controlling a plurality of functions of the machine; a control lever converter, operably coupled to the at least two control levers and configured to generate signals in response to manipulation of each of the control levers; a processing unit, in communication with the control lever converter and a display panel coupled to the steering means and disposed below the transparent panel; and a display panel forming a part of the HMI, the processing unit configured to receive converted signals, and directing the display panel to update displayed information, wherein the displayed information is displayed with a plurality of icons formed by a predetermined icon segment combination.

In another embodiment, provided herein is a system for facilitating a user to simultaneously control a mobile communication device and a plurality of vehicle functions, implementable in a human-machine interface (HMI), the system comprises: an integral docking station configured to engage and communicate with a mobile communication device; a docking station controller; and a system for providing a display panel as part of a human-machine interface (HMI), comprising: potentially a front transparent panel coupled to a vehicle's steering means; at least two control levers disposed on and/or under a surfaces of the steering means for controlling a plurality of functions of the machine; a control lever converter, operably coupled to the at least two control levers and configured to generate signals in response to manipulation of each of the control levers; a processing unit, in communication with the control lever converter and a display panel coupled to the steering means and disposed below the transparent panel; and a display panel forming a part of the HMI, the processing unit coupled to a non-volatile memory having a processor-readable medium thereon with a set of executable instructions configured to: receive converted signals; direct the display panel to update displayed information, wherein the displayed information is displayed with a plurality of icons formed by a predetermined icon segment combination; communicate with the integral docking station controller; convert docking station controller signal to executable commands controlling the vehicle; and convert the control levers converter signal to executable commands controlling the mobile communication device.

These and other features of the systems for providing at least a part of HMI system and system components for controlling a vehicle, controlling a personal or mobile communication device (e.g., smartphone) and displaying information to the user will become apparent from the following detailed description when read in conjunction with the drawings, which are exemplary, not limiting.

### BRIEF DESCRIPTION OF THE FIGURES

For a better understanding of the HMI systems, with regard to the embodiments thereof, reference is made to the accompanying drawings, in which:

FIG. 1, is an illustration of the steering means comprising the HMI;

FIG. 2, is an illustration of a quasi-exploded view of the display panels;

FIGS. 3-5 illustrate a segmented partial display (FIG. 3), a complementary display (FIG. 4) and a combination display (FIG. 5)

FIG. 6, is a schematic illustration of icon segments and the resulting display of the icons;

FIG. 7, is an illustration of an embodiment of the input sensors positioning used to control a plurality of system;

FIG. 8, is a table detailing an embodiment of the vehicle systems affected by the HMI;

FIG. 9, is a block diagram illustrating the interactions among the HMI system's components including a mobile communication device; and

FIG. 10, illustrates the HMI system interrelation with the cloud and a personal communication device.

### DESCRIPTION

Provided herein are embodiments of systems for providing a display panel as part of a human-machine interface (HMI) and system components for facilitating a user or driver, using a mobile communication—controlling a plurality of functions of a vehicle, and/or using vehicle control levers, controlling a mobile computing and communication device and displaying information to the user.

The systems provided herein can provide an integrated control interface for the user of the vehicle, for example, a foldable motorized scooter. The control interface employs a plurality (in other words, at least two) of multi-functional switches or “control levers” located proximate to the user in combination with a display that provides an indicia of the vehicle subsystems' function controlled by each switch or combination of switches, as well as through an integral docking station, the vehicle is controlled by a mobile communication device (or smartphone). A user, absorbing audiovisual environmental stimuli will react by actuating the control levers, or gestures applied to the mobile communication device's display screen, such that control module or processor, in communication with the HMI receives control signals from the switches (or plurality of control levers) and/or the mobile communication device; and executes control of the applicable vehicle subsystem function in response thereto.

Accordingly and in an embodiment, provided herein is a system for providing a display panel as part of a human-machine interface (HMI), comprising: potentially a front transparent panel coupled to a vehicle's steering means; at least two control levers disposed on and/or under a surfaces of the steering means for controlling a plurality of functions of the machine; a control lever converter, operably coupled to the at least two control levers and configured to generate signals in response to manipulation of each of the control levers; a processing unit, in communication with the control lever converter and a display panel coupled to the steering means and disposed below the transparent panel; and a display panel forming a part of the HMI, the processing unit configured to receive converted signals, and directing the display panel to update displayed information, wherein the displayed information is displayed with a plurality of icons formed by a predetermined icon segment combination.

The terms “user”, “customer”, “consumer” and formatives thereof as utilized herein refer to any party desiring to initiate interaction with an information and service accessible by the systems and system described herein.

In an embodiment, the HMI system can comprise a processing unit, or processing module comprising a central processing unit (CPU) that is microprocessor-based. The processing unit can perform various functions including controlling the display, as well as being in communication with a user interface (UI). The user interface may be one or a combination of different types of user interfaces depending upon the system. The user interface can be used to provide various inputs and responses to elements displayed on the display. When the user interface is a touch screen or touch display, the screen display and the user interface may be one in the same. More than one user interface may be incorporated into the steering means.

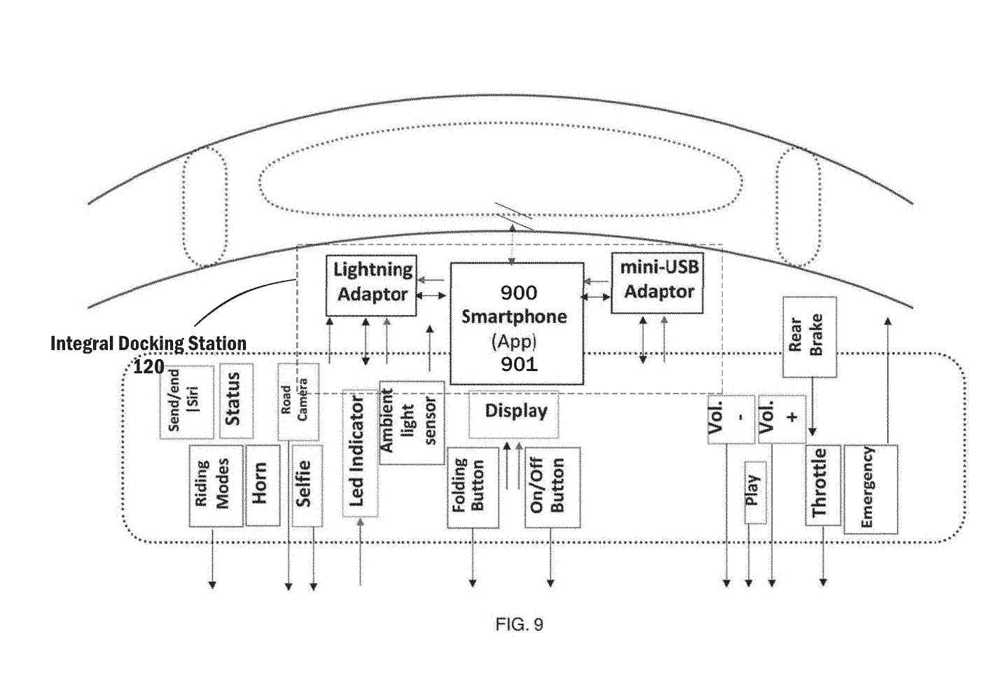

A memory component can also be in communication with the processing unit. The memory component may include different types of memory that store different types of data. The memory component may store operating software for the system, operating data, user settings, music, documents, multimedia files and applications. The applications may perform various functions, including an application for communicating with a smartphone illustrated in FIG. 9 and obtaining data from the wearable device and/or a back end management or content server. The application may allow the HMI to communicate directly with a content management server.

In addition, provided herein is a non-transitory processor-readable storage medium having stored thereon processor-executable software instructions configured to cause a processor to perform operations associated with systems for providing a display panel as part of a human-machine interface (HMI), comprising: potentially a front transparent panel coupled to a vehicle's steering means; at least two control levers disposed on and/or under a surfaces of the steering means for controlling a plurality of functions of the machine; a control lever converter, operably coupled to the at least two control levers and configured to generate signals in response to manipulation of each of the control levers; a processing unit, in communication with the control lever converter and a display panel coupled to the steering means and disposed below the transparent panel; and a display panel forming a part of the HMI, the processing unit configured to receive converted signals, and directing the display panel to update displayed information, wherein the displayed information is displayed with a plurality of icons formed by a predetermined icon segment combination.

The term “computer-readable medium” or “processor-readable medium” as used herein refers to any medium that participates in providing information to the processor, including instructions for execution. Such a medium may take many forms, including, but not limited to computer-readable storage medium (e.g., non-volatile media), and transmission media. Non-transitory media, such as non-volatile media, include, for example, optical or magnetic disks. Volatile media include, for example, dynamic memory. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

All ranges disclosed herein are inclusive of the endpoints, and the endpoints are independently combinable with each other. Furthermore, the terms “first,” “second,” and the like, herein do not denote any order, quantity, or importance, but rather are used to denote one element from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the DMD(s) includes one or more dislocated mobile device).

Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The term “plurality”, as used herein, is defined as two or as more than two. The term “another”, as used herein, is defined as at least a second or more. The terms “including” and/or “having”, as used herein, are defined as comprising (i.e., open language).

The term “communication” and its derivatives (e.g., “in communication”) may refer to a shared bus configured to allow communication between two or more devices, or to a point to point communication link configured to allow communication between only two (device) points. Likewise, the term “operatively coupled” or “operably coupled” refers to a connection between devices or portions thereof that enables operation in accordance with the present system. For example, an operative coupling may include one or more of a wired connection and/or a wireless connection between two or more devices that enables a one and/or two-way communication path between the devices or portions thereof. In addition, an operable coupling may include a communication path through a wired and/or wireless network, such as a connection utilizing the Internet. The term contact center is utilized herein to describe a support/service center and as such, may be a contact center, call center, etc.

“Transparent” refers to a thermoplastic front panel composition capable of at least 70% transmission of light. Likewise the term “transparent” as used herein would also refer to a thermoplastic front panel composition that transmits at least 70% in the region ranging from 250 nm to 700 nm with a haze of less than 10%.

A more complete understanding of the components, methods, and devices disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof, their relative size relationship and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

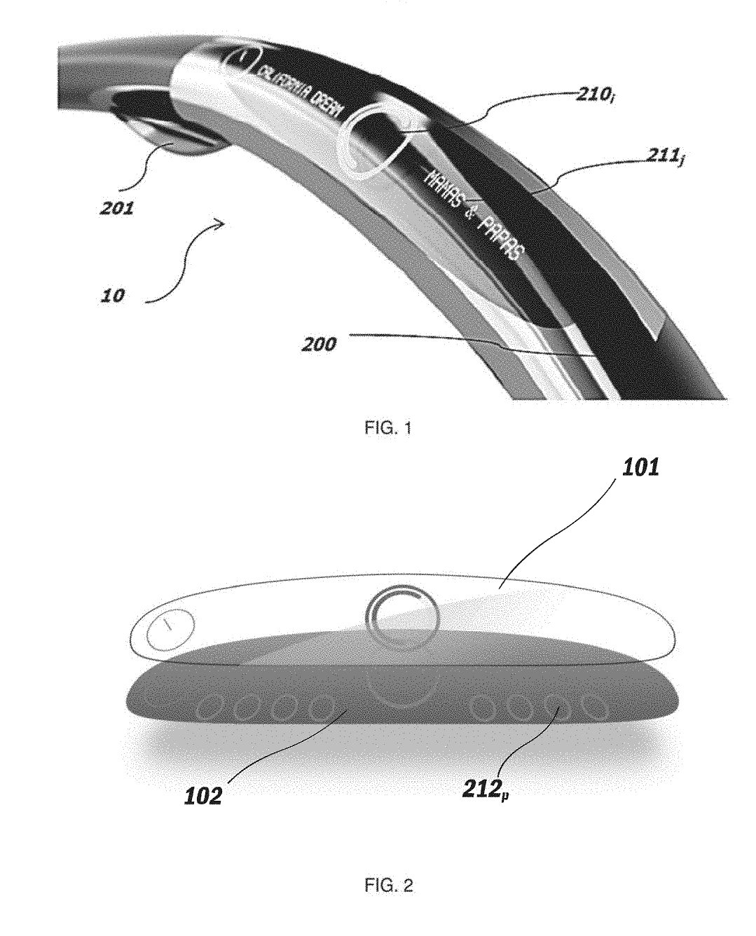

Turning now to FIG. 1, illustrating steering means 10 (e.g., handlebar, or HB) comprising HMI 200, signaling levers 201 with segmented display 210ᵢ, and text display 211ⱼ.

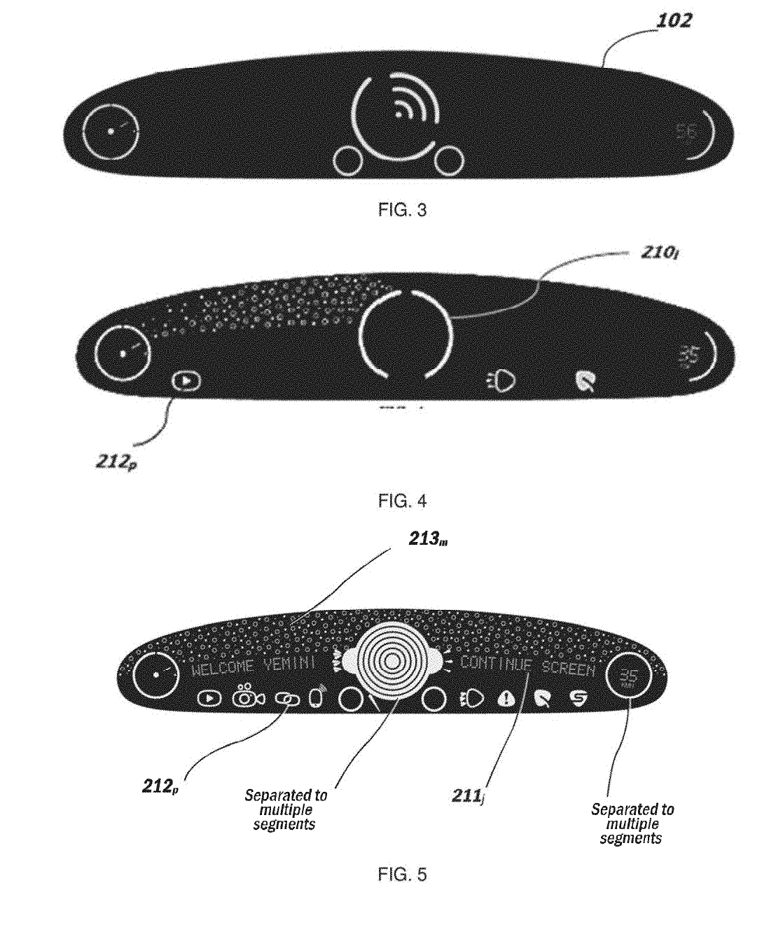

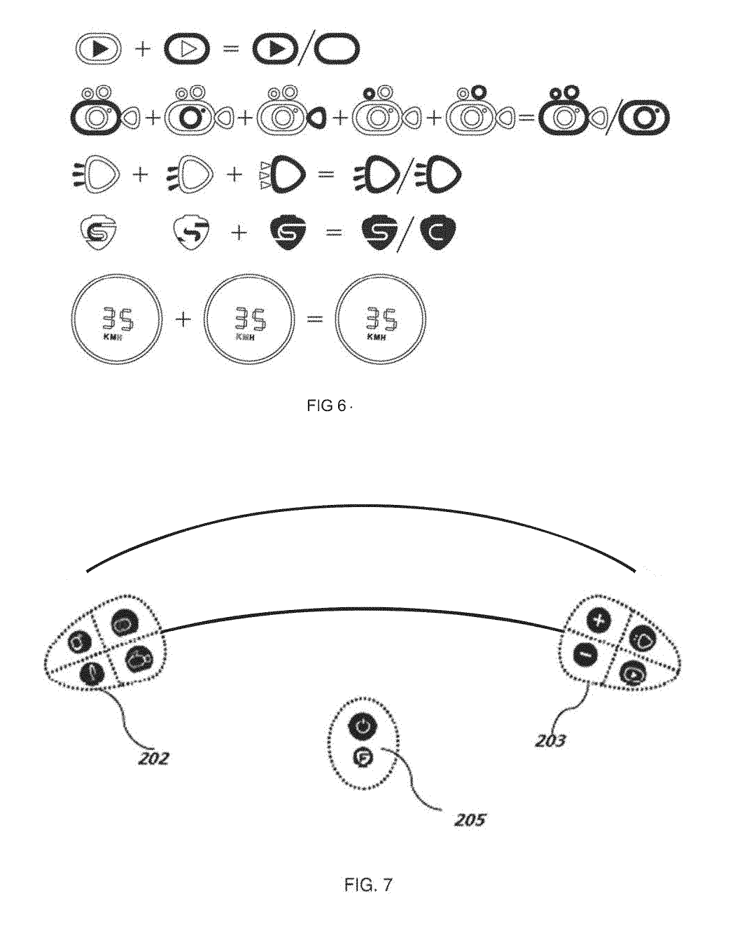

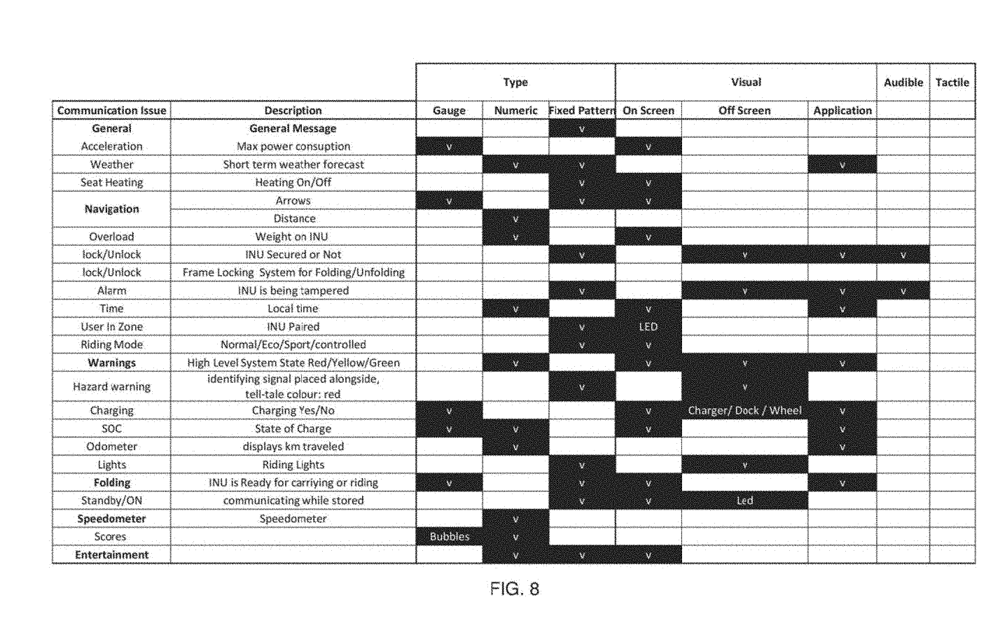

Turning now to FIGS. 2-7 illustrating a quasi-exploded view of system 200 for providing a part of human-machine interface (HMI) in FIG. 2, comprising: upper transparent panel 101 coupled to vehicle steering means 10, see e.g., FIG. 1; at least two control levers 202, 203, 205 see e.g., FIG. 7, disposed on and/or under a surfaces of steering means 10 (e.g., in series) for controlling a plurality of functions of the machine; a control lever(s) converter (not shown, e.g. A/D converter and/or D/A converter, a digital signal processor (DSP) and the like) coupling control levers 202, 203, 205, and generating signals in response to touches on; or generally actuating control levers 202, 203, 205 at different times) and a processing unit (not shown) coupling the control lever(s) converter and a display panel 102 coupled to steering means 10 and disposed below transparent panel 101 (for example, about 1 cm below), wherein the control lever(s) converter (e.g., button 202) can be configured to convert received signals, and directing display panel 102 to update the displayed information, wherein the displayed information can be displayed with a plurality of icons (see e.g., FIG. 6) formed by a predetermined icon segment combination.

The icons (see e.g., FIG. 6) displaying the information can be configured to provide information on: all items disclosed in the table provided herein and in FIG. 8:

As illustrated in FIG. 9, the systems described herein can further comprising a docking port (an integral docking station) configured to engage and communicate with a personal communication device. The personal communication device can be, for example a smartphone, a phablet and the like. Furthermore, the system can comprise a transceiver operably coupled to the processing unit, in communication with a wearable device, the personal communication device or both, wherein the transceiver is configured to convert gestures made by a user and captured by the wearable device and/or the personal communication device to signals capable of being processed by the processing unit.

The body gesture implementation can be based on a motion sensor and/or image recognition based technology that will be used as wearable device or mounted camera on steering means 10 or its (e.g., blue tooth) paired smartphone (see e.g., FIG. 9). The gesture enabled device can communicate with the microprocessor unit to control the vehicle. In addition, the gesture enabling device (e.g., wearable bracelet, or smartphone) can be configured to detect the gesture and the processor or the gesture enabling device can be configured to perform the gesture validation and “call to action”, or execute a gesture-corresponding command.

Conversely, the gesture enabled device can be used to control other functions of the mobile communication device and integrate those into the vehicle display. As a preliminary matter, the user receives visual and audible stimulus and use those to control two separate but interfaced (via the HMI) instruments. The vehicle itself V, through the control levers located on the handlebar, as well as the smartphone which is interfaced via the docking port (or docking station).

Accordingly and in an embodiment, provided herein is a system for facilitating a user to simultaneously control a mobile communication device and a plurality of vehicle functions, implementable in a human-machine interface (HMI), the system comprises: an integral docking station configured to engage and communicate with a mobile communication device; a docking station controller; and a system for providing a display panel as part of a human-machine interface (HMI), comprising: potentially a front transparent panel coupled to a vehicle's steering means; at least two control levers disposed on and/or under a surfaces of the steering means for controlling a plurality of functions of the machine; a control lever converter, operably coupled to the at least two control levers and configured to generate signals in response to manipulation of each of the control levers; a processing unit, in communication with the control lever converter and a display panel coupled to the steering means and disposed below the transparent panel; and a display panel forming a part of the HMI, the processing unit coupled to a non-volatile memory having a processor-readable medium thereon with a set of executable instructions configured to: receive converted signals; direct the display panel to update displayed information, wherein the displayed information is displayed with a plurality of icons formed by a predetermined icon segment combination; communicate with the integral docking station controller; convert docking station controller signal to executable commands controlling the vehicle; and convert the control levers converter signal to executable commands controlling the mobile communication device.

Actions that can be initiated using gestures can be, for example;

1. Vehicle Fold and UnFold Action:
Hand gesture that is used for commanding the Fold and unfold action of the Vehicle. It can be 2 different hand gestures for the Fold and UnFold or the same hand gesture that toggles between them.

2. User Authentication
Using the hand gesture signature or other pattern recognition protocol (Conceptually Similar to the authentication drawing for android phones).
Each use will be able to record its personal “gesture signature” and use it to lock and unlock the vehicle (Electronically)

3. Head Gestures
During riding time the rider's hands are not available though his head is located in front of the smartphone's camera.
This can be used to perform simple command actions (like confirm/non confirm) by head gestures for actions request from the smartphone app.

4. Mobile Communication Device Control
Using the gesture controls and/or other controls, controlling functions such as changing applications, providing voice command and control, enabling blue tooth communication, providing status updates on social media and other messaging systems, taking the user pictures (without releasing the handlebar)—“Selfi” and other similar functions. The mobile communication device enablement can be done using a dedicated application configured to provide the communication protocols between the personal mobile communication device and the vehicle's processing unit.

In an embodiment, the handlebar comprising the systems and system described herein can be used to control the mobile communication device described herein. Further, functions controlled by the vehicles' sensors and controllers can be integrated into the vehicle's display. These functions can comprise use of navigation application, music applications etc.

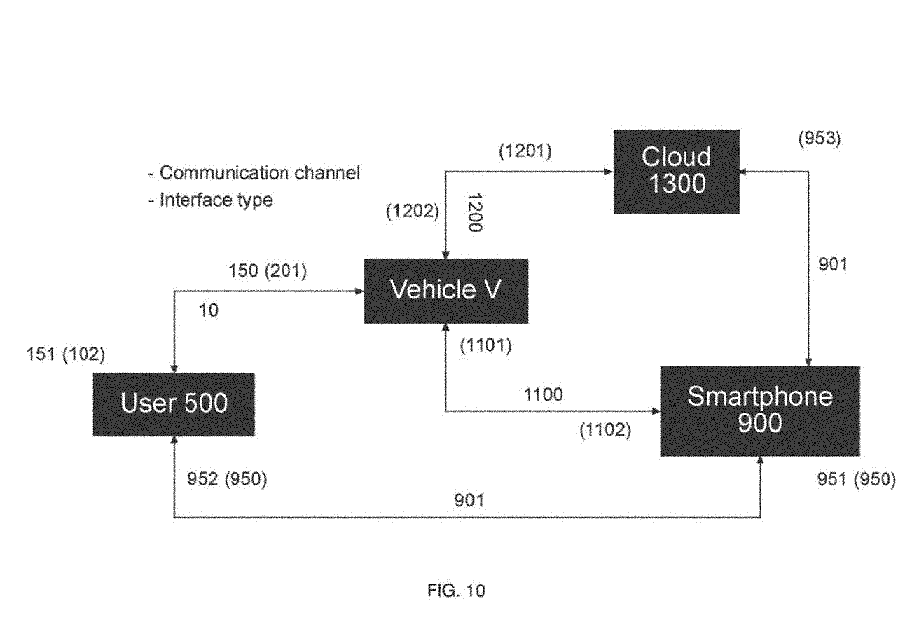

Turning now to FIG. 10, illustrating the HMI system architecture, depicting the interrelation between the various components of the system, including the various interface types and the communication channels used among the various system's components. As illustrated, vehicle V acts as a hub for incoming communication from user 500, cloud 1300 and mobile communication device 900 (interchangeable with smartphone wherever used). Communication with cloud 1300 can be two-way communication using, for example cellular communication channel 1200 whereby, the vehicle on-board processor can be configured to transmit, for example, usage statistics data 1201 to a management server in cloud 1300, and receive, from cloud 1300—residing management, or back-end server, or their combination, software update or other important data 1202. For example, using the usage data interface with the cloud, the user can get real time data on various user-specific parameters. These can be, for example, battery and power management, scheduled maintenance, weather warnings, remaining battery/range and the like. Additionally, the HMI can interface with other objects and generally connect with the internet-of-things (IOT). Furthermore, the backend management server residing on the cloud, can be used to track malfunctions and provide location data to emergency service providers. The interface between cloud 1300 and vehicle V, can be, for example the transceiver coupled to the on-board processing unit.

Additionally, vehicle V can interface with personal mobile communication device, or smartphone 900 (see e.g. FIG. 9) having a processing module thereon, coupled to a non-volatile memory (in other words, memory that does not delete data upon loss of power) with a set of processor-readable set of instructions (in other words, an application, or app 901), configured to facilitate communication, control, and convert gestures sensed and provided by a touch screen 950 of smartphone 900. Smartphone 900 can also interface with vehicle V via docking station 120 (see e.g., FIG. 9), with cloud-residing back end and/or application server via app 901 using cellular communication channel 1200. Communication between user 500 and smartphone 900 can be done using app 901 interfacing with smartphone 901 touchscreen 950 or other controls on smartphone 900. Once engaged in docking station (or port) 120, user 500 can interface with smartphone 900 using, for example handlebar 10 controls 201. Communication channel between smartphone 900 and vehicle V, facilitated by docking station (or port) 120, can be done for example, using Blue Tooth 100, either sending control commands 1102 to smartphone 900, thereby controlling smartphone 900 functions (e.g., camera, music, communication etc.), or alternatively, receiving control commands 1101 from smartphone 900 using smartphone touchscreen display 950.

The systems for facilitating a user to simultaneously control a mobile communication device and a plurality of vehicle functions, implementable in the human-machine interface (HMI) provided herein can further comprise a transceiver in communication with the mobile communication device and is also operably coupled to the vehicle's processing unit.

The transceiver in turn, can be configured to convert gestures made by a user and captured by the mobile communication device's display screen or other controls capable of capturing gestures made by the user; to signals capable of being processed by the vehicle's processing unit and communicate these signals to the vehicle's processing unit (e.g., using Blue Tooth communication. For example, the gestures can be captured by a rear-facing camera integral to the mobile communication device.

Moreover, the docking station controller used in the systems for facilitating a user to simultaneously control a mobile communication device and a plurality of vehicle functions described herein, can comprise a plurality of buttons (which can be icons when a touchscreen is used) disposed on the steering means. In an embodiment, the integral docking station can be configured to communicate with the mobile communication device via Blue Tooth communication, and communicate with a back-end server residing on the cloud via cellular communication network. The term “cellular communication network” as used herein in this application, is defined as any network based communication system that is based upon geographical partition of space into cells. Each cell is provided with at least one base station that manages the communication therein. Each cell comprises a plurality of cell sectors, wherein each sector is usually associated with a physical network end point that enables the communication with a network-connected device. Various cellular communication standards are currently in use while other are being developed. The popular ones are, for example: UMTS, HSPA, GSM, CDMA-2000, TD-SCDMA, LTE and WiMAX.

Additionally, the transceivers used in the HMI systems described herein, in combination with the processing unit of the vehicle and the processing module of the mobile communication device—can be configured to provide two-way communication among all the systems' components. The term “two-way communication” refers to establishing a two-way communication channel, meaning a communications channel that allows bidirectional communication; it may comprise two unidirectional communications channels. Also, the term “two-way communication” may refer to communication that includes listening to audio (e.g., via a speaker) and generating an audio message (e.g., a microphone).

In an embodiment, the mobile communication device can be in two-way communication with the remote management server over cellular communication network,

Accordingly, provided herein is a system for providing a display panel as part of a human-machine interface (HMI), comprising: potentially a front transparent panel coupled to a vehicle's steering means; at least two control levers disposed on and/or under a surfaces of the steering means for controlling a plurality of functions of the machine; a control lever converter, operably coupled to the at least two control levers and configured to generate signals in response to manipulation of each of the control levers; a processing unit, in communication with the control lever converter and a display panel coupled to the steering means and disposed below the transparent panel; and a display panel forming a part of the HMI, the processing unit configured to receive converted signals, and directing the display panel to update displayed information, wherein the displayed information is displayed with a plurality of icons formed by a predetermined icon segment combination, wherein (i) the steering means is a handlebar, wherein (ii) the icons displaying the information are configured to provide information on: acceleration, seat heating status, navigation, vehicle load, time, other users of the same vehicle, riding mode, warning, battery status, lights type and status, entertainment, or a combination comprising two or more of the foregoing, further comprising (iii) an integral docking port (interchangeable with integral docking station), configured to engage and communicate with a mobile communication device, further comprising (iv) a transceiver operably coupled to the processing unit, in communication with a wearable device, the mobile communication device or both, wherein the transceiver is configured to convert gestures made by a user and captured by the wearable device and/or the mobile communication device to signals capable of being processed by the processing unit, (v) the transceiver being integral to the personal communication device or the wearable device, and wherein (vi) the processing unit is configured to control a plurality of functions of the vehicle at least a portion of which are being displayed by the HMI, (vii) the vehicle function is; folding the vehicle, performing user authentication, locking and unlocking the vehicle, accelerating, providing alarms, providing status updates to a messaging system, or a combination of functions comprising the foregoing.

In another embodiment, provided herein is a system for providing human-machine-interface (HMI) for a vehicle, the system comprising a vehicle having a steering means; an system for providing a panel as part of human-machine interface (HMI), comprising: a front transparent panel coupled to a vehicle steering means; at least two controls disposed on and/or under a surfaces of the steering means in series for controlling a plurality of functions of the machine; a control lever(s) convertercoupling the side sensors, and generating signals in response to touches on the side sensors at different times; and a processing unit coupling the control lever(s) converter and a display panel coupled to the steering means and disposed below the transparent panel, wherein the control lever(s) converter is configured to convert received signals, and directing the front panel to update the displayed information, wherein the displayed information is displayed with a plurality of icons formed by a predetermined icon segment combination; optionally a personal communication device; and optionally a wearable device configured to capture gesture be a user of the vehicle.

In yet another embodiment, provided herein is a system for facilitating a user to simultaneously control a mobile communication device and a plurality of vehicle functions, implementable in a human-machine interface (HMI), the system comprises: an integral docking station configured to engage and communicate with a mobile communication device; a docking station controller; and a system for providing a display panel as part of a human-machine interface (HMI), comprising: potentially a front transparent panel coupled to a vehicle's steering means; at least two control levers disposed on and/or under a surfaces of the steering means for controlling a plurality of functions of the machine; a control lever converter, operably coupled to the at least two control levers and configured to generate signals in response to manipulation of each of the control levers; a processing unit, in communication with the control lever converter and a display panel coupled to the steering means and disposed below the transparent panel; and a display panel forming a part of the HMI, the processing unit coupled to a non-volatile memory having a processor-readable medium thereon with a set of executable instructions configured to: receive converted signals; direct the display panel to update displayed information, wherein the displayed information is displayed with a plurality of icons formed by a predetermined icon segment combination; communicate with the integral docking station controller; convert docking station controller signal to executable commands controlling the vehicle; and convert the control levers converter signal to executable commands controlling the mobile communication device, wherein (ix) the steering means is a handlebar, further comprising (x) a transceiver in communication with the mobile communication device operably coupled to the processing unit, wherein the transceiver is configured to convert gestures made by a user and captured by the mobile communication device to signals capable of being processed by the processing unit (xi) the transceiver being an integral part of the mobile communication device, wherein (xii) the gestures are captured by a rear-facing camera integral to the mobile communication device, wherein (xiii) the docking station controller comprises a plurality of buttons disposed on the steering means, wherein (xiv) the integral docking station is configured to communicate with the mobile communication device via Blue Tooth communication, and (xv) the mobile communication device further comprises a processing module, the processing module coupled to a non-volatile memory having a processor-readable medium thereon with a set of executable instructions dedicated to the HMI, (xvi) the (vehicle's and/or the mobile communication device's) transceiver is in two-way communication with a remote management server over cellular communication network, and wherein (xvii) the mobile communication device is in two-way communication with the remote management server over cellular communication network.

While particular embodiments have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

1. A system for providing a display panel as part of a human-machine interface (HMI), comprising:
a. potentially a front transparent panel coupled to a vehicle's steering means;
b. at least two control levers disposed on and/or under a surfaces of the steering means for controlling a plurality of functions of the machine;
c. a control lever converter, operably coupled to the at least two control levers and configured to generate signals in response to manipulation of each of the control levers;
d. a processing unit, in communication with the control lever converter and a display panel coupled to the steering means and disposed below the transparent panel; and
e. a display panel forming a part of the HMI, the processing unit configured to receive converted signals, and directing the display panel to update displayed information, wherein the displayed information is displayed with a plurality of icons formed by a predetermined icon segment combination.

2. The system of claim 1, wherein the steering means is a handlebar.

3. The system of claim 1, wherein the icons displaying the information are configured to provide information on: acceleration, seat heating status, navigation, vehicle load, time, other users of the same vehicle, riding mode, warning, battery status, lights type and status, entertainment, or a combination comprising two or more of the foregoing.

4. The system of claim 1, further comprising an integral docking port configured to engage and communicate with a mobile communication device.

5. The system of claim 4, further comprising a transceiver operably coupled to the processing unit, in communication with a wearable device, the mobile communication device or both, wherein the transceiver is configured to convert gestures made by a user and captured by the wearable device and/or the mobile communication device to signals capable of being processed by the processing unit.

6. The system of claim 5, wherein the processing unit is configured to control a plurality of functions of the vehicle at least a portion of which are being displayed by the HMI.

7. The system of claim 6, wherein the plurality of vehicle functions comprise folding the vehicle, performing user authentication, locking and unlocking the vehicle, accelerating, providing alarms, providing status updates to a messaging system, or a combination of functions comprising the foregoing.

8. A system for facilitating a user to simultaneously control a mobile communication device and a plurality of vehicle functions, implementable in a human-machine interface (HMI), the system comprises:
a. an integral docking station configured to engage and communicate with a mobile communication device;
b. a docking station controller; and
c. a system for providing a display panel as part of a human-machine interface (HMI), comprising:
i. potentially a front transparent panel coupled to a vehicle's steering means;
ii. at least two control levers disposed on and/or under a surfaces of the steering means for controlling a plurality of functions of the machine;
iii. a control lever converter, operably coupled to the at least two control levers and configured to generate signals in response to manipulation of each of the control levers;
iv. a processing unit, in communication with the control lever converter and a display panel coupled to the steering means and disposed below the transparent panel; and
v. a display panel forming a part of the HMI,
the processing unit coupled to a non-volatile memory having a processor-readable medium thereon with a set of executable instructions configured to:
receive converted signals;
direct the display panel to update displayed information, wherein the displayed information is displayed with a plurality of icons formed by a predetermined icon segment combination;
communicate with the integral docking station controller;
convert docking station controller signal to executable commands controlling the vehicle; and
convert the control levers converter signal to executable commands controlling the mobile communication device.

9. The system of claim 8, wherein the steering means is a handlebar.

10. The system of claim 9, further comprising a transceiver in communication with the mobile communication device operably coupled to the processing unit, wherein the transceiver is configured to convert gestures made by a user and captured by the mobile communication device to signals capable of being processed by the processing unit.

11. The system of claim 10, wherein the gestures are captured by a rear-facing camera integral to the mobile communication device.

12. The system of claim 11, wherein the docking station controller comprises a plurality of buttons disposed on the steering means.

13. The system of claim 12, wherein the integral docking station is configured to communicate with the mobile communication device via Blue Tooth communication.

14. The system of claim 13, wherein the mobile communication device further comprises a processing module, the processing module coupled to a non-volatile memory having a processor-readable medium thereon with a set of executable instructions dedicated to the HMI.

15. The system of claim 14, wherein the transceiver is in two-way communication with a remote management server over cellular communication network.

16. The system of claim 15, wherein the mobile communication device is in two-way communication with the remote management server over cellular communication network.

17. The system of claim 8, wherein the vehicle is a foldable motorized scooter.

18. The system of claim 17, wherein the vehicle function controlled by the human machine interface is the folding of the foldable motorized scooter.

19. The system of claim 1, wherein the processing unit is further configured to provide interface for controlling the vehicle using head gestures.

20. The system of claim 8, wherein the set of executable instructions is further configured to provide interface for controlling the vehicle using head gestures.
